(19) United States
(12) Patent Application Publication
(10) Pub. No.: US 2025/0284319 A1
(43) Pub. Date: Sep. 11, 2025

(54) ELECTRONIC DEVICE COMPRISING FLEXIBLE DISPLAY, AND METHOD FOR CONTROLLING SAME

(71) Applicant: Samsung Electronics Co., Ltd., Suwon-si (KR)

(72) Inventors: Gwangchae JUNG, Suwon-si (KR); Kijin KWON, Suwon-si (KR); Kisung KIM, Suwon-si (KR); Minhoo PARK, Suwon-si (KR); Sangil PARK, Suwon-si (KR); Wooseok LEE, Suwon-si (KR); Chongyoon CHUNG, Suwon-si (KR); Dohyung HA, Suwon-si (KR)

(21) Appl. No.: 19/216,106

(22) Filed: May 22, 2025

Related U.S. Application Data
(63) Continuation of application No. PCT/KR2023/017131, filed on Oct. 31, 2023.

(30) Foreign Application Priority Data
Nov. 30, 2022 (KR) 10-2022-0163841
Dec. 16, 2022 (KR) 10-2022-0176435

(51) Int. Cl. G06F 1/16; G06F 3/0481

(52) U.S. Cl. CPC G06F 1/1652; G06F 1/1624; G06F 3/0481; G06F 2203/04803

(57) ABSTRACT

An electronic device may include: a housing; at least one sensor; a flexible display having at least part exposed to the outside through the housing; and at least one processor operatively connected to the at least one sensor and the flexible display, wherein the at least one processor may identify through the at least one sensor whether at least a part of the flexible display is covered while the flexible display is slid in with respect to the housing, perform a sliding-out operation of the flexible display on the basis of an event occurring while at least a part of the flexible display is covered, and display information related to the event, in an area expanded by the sliding-out operation.

### CROSS-REFERENCE TO RELATED APPLICATIONS

This application is a continuation application of International Application No. PCT/KR2023/017131 designating the United States, filed on Oct. 31, 2023, in the Korean Intellectual Property Receiving Office and claiming priority to Korean Patent Application No. 10-2022-0163841 filed on Nov. 30, 2022, and Korean Patent Application 10-2022-0176435 filed on Dec. 16, 2022, the disclosures of which are all hereby incorporated by reference herein in their entireties.

### TECHNICAL FIELD

Certain example embodiments may relate to an electronic device including a flexible display and/or a method for controlling the same.

### BACKGROUND ART

As the demand for mobile communication increases, or as the degree of integration of electronic devices increases, the portability of electronic devices such as mobile communication terminals may be increased, and better convenience may be provided in use of multimedia functions. For example, as touchscreen-integrated displays replace traditional mechanical (button-type) keypads, electronic devices may come more compact while functioning as an input device. For example, as the mechanical keypad may be omitted from the electronic device, portability of the electronic device may be improved. As the display area may be expanded to the area which used to be occupied by the mechanical keypad, the electronic device may provide a larger screen while remaining in the same size and weight as when it has the mechanical keypad.

Use of an electronic device with a larger screen may give more convenience in, e.g., web browsing or multimedia playing. A larger display may be adopted to output a larger screen. However, this way may be limited by the portability of the electronic device. According to an embodiment, a display using organic light emitting diodes may secure the portability of the electronic device while providing a larger screen. For example, a display using, or equipped with, organic light emitting diodes may implement a stable operation even if it is made quite thin, so that the display may be applied to an electronic device in a foldable, bendable or rollable form.

### SUMMARY

According to an example embodiment, an electronic device may comprise a housing, at least one sensor, a flexible display at least partially visible to an outside through the housing, memory storing at least one instruction, and at least one processor, comprising processing circuitry, operatively connected directly or indirectly to the at least one sensor, the flexible display and the memory.

According to an example embodiment, the at least one processor may identify whether a portion of the flexible display is covered through the at least one sensor in a state in which the flexible display slides in with respect to the housing.

According to an example embodiment, the at least one processor may perform a slide-out operation of the flexible display based on an occurrence of an event in the state in which the portion of the flexible display is covered.

According to an example embodiment, the at least one processor may display information related to the event in an area exposed by the slide-out operation, wherein the exposed area corresponds to the covered portion.

According to an example embodiment, a method for controlling an electronic device may comprise identifying whether a portion of a flexible display is covered through at least one sensor in a state in which the flexible display slides in with respect to a housing.

According to an example embodiment, the method for controlling the electronic device may comprise sliding out the flexible display based on an occurrence of an event in the state in which the portion of the flexible display is covered.

According to an example embodiment, the method for controlling the electronic device may comprise displaying information related to the event in an area exposed by the slide-out operation, wherein the exposed area corresponds to the covered portion.

### BRIEF DESCRIPTION OF DRAWINGS

FIG. 1 is a block diagram illustrating an electronic device in a network environment according to an example embodiment;

FIG. 2 is a view illustrating a state in which a second display area of a display is received in a housing according to an example embodiment.

FIG. 3 is a view illustrating a state in which a second display area of a display is exposed to the outside of a housing according to an example embodiment;

FIG. 4 is an exploded perspective view illustrating an electronic device according to an example embodiment;

FIG. 5A is a cross-sectional view taken along line A-A′ of FIG. 2 according to an example embodiment;

FIG. 5B is a cross-sectional view taken along line B-B′ of FIG. 3 according to an example embodiment;

FIG. 6 is a flowchart illustrating an extending operation when an event occurs in a state in which at least a portion of a flexible display of an electronic device is covered according to an example embodiment;

FIG. 7 is a view illustrating a use example when an electronic device is mounted on a flip cover according to an example embodiment;

FIG. 8A is a view illustrating an operation of extending a flexible display of an electronic device in a vertical direction in a state in which at least a portion thereof is covered according to an example embodiment;

FIG. 8B is a view illustrating an operation of extending a flexible display of an electronic device in a horizontal direction in a state in which at least a portion thereof is covered according to an example embodiment;

FIG. 9A is a view illustrating an extending operation based on an application where an event occurs, in a state in which at least a portion of a flexible display of an electronic device is covered according to an example embodiment;

FIG. 9B is a view illustrating an extending operation based on an application where an event occurs, in a state in which at least a portion of a flexible display of an electronic device is covered according to an example embodiment;

FIG. 10 is a view illustrating a stepwise extending operation when an event occurs in a state in which at least a portion of a flexible display of an electronic device is covered according to an example embodiment;

FIG. 11A is a view illustrating an operation in which a screen configuration is varied during stepwise extension in a state in which at least a portion of a flexible display of an electronic device is covered according to an example embodiment;

FIG. 11B is a view illustrating an operation in which a screen configuration is varied during stepwise extension in a state in which at least a portion of a flexible display of an electronic device is covered according to an example embodiment;

FIG. 12 is a view illustrating an operation of obtaining an image based on an aspect ratio of an extended area when a camera application is executed in a state in which at least a portion thereof a flexible display of an electronic device is covered according to an example embodiment;

FIG. 13A is a view illustrating a configuration screen for receiving a user input for setting to display a widget when a flexible display is extended based on an occurrence of an event in a state in which at least a portion of a flexible display of an electronic device is covered according to an example embodiment; and

FIG. 13B is a view illustrating a widget displayed based on a degree of extension of a flexible display in a state in which at least a portion of a flexible display of an electronic device is covered according to an example embodiment.

### DETAILED DESCRIPTION

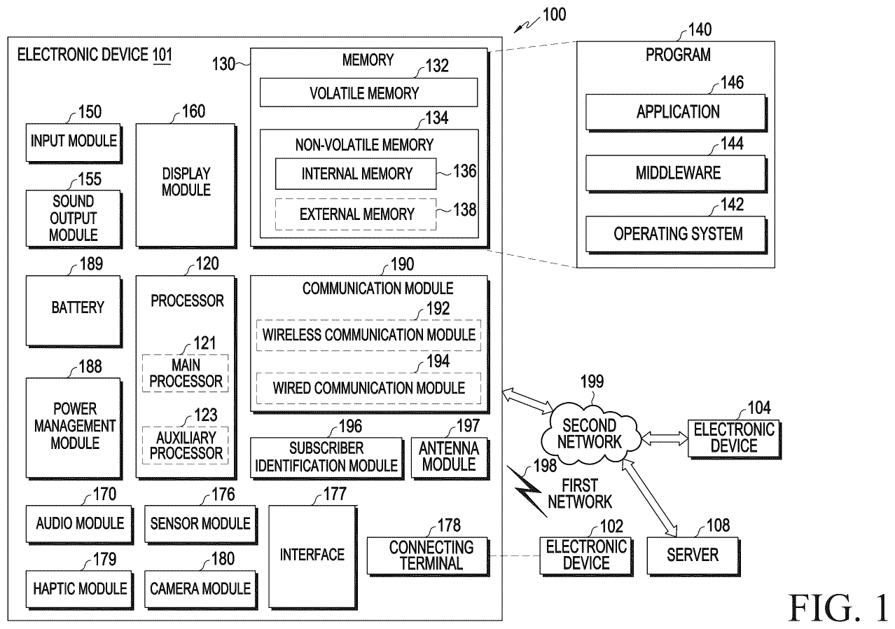

FIG. 1 is a block diagram illustrating an electronic device 101 in a network environment 100 according to an embodiment. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

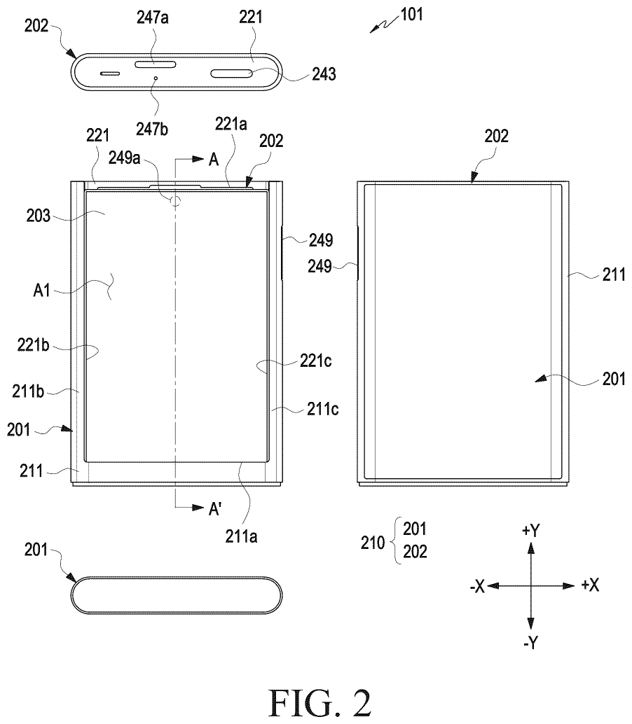

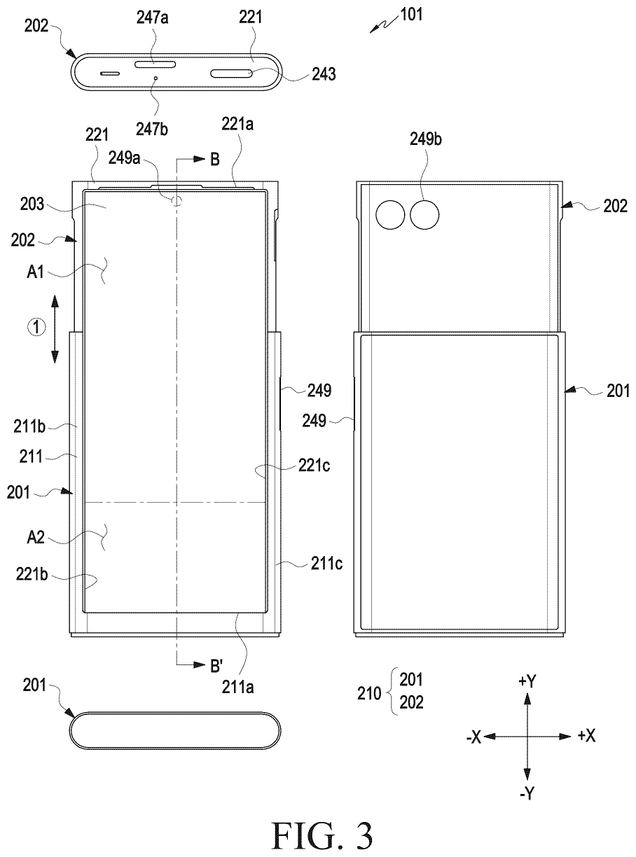

FIG. 2 is a view illustrating a state in which a second display area of a display is received in a housing according to an embodiment. FIG. 3 is a view illustrating a state in which a second display area of a display is exposed to the outside of a housing according to an embodiment.

FIGS. 2 and 3 illustrate a structure in which the display 203 (e.g., flexible display or rollable display) is extended in the length direction (e.g., +Y direction) when the electronic device 101 is viewed from the front. However, the extending direction of the display 203 is not limited to one direction (e.g., +Y direction). For example, the extending direction of the display 203 may be changed in design to be extendable in the upper direction (+Y direction), right direction (e.g., +X direction), left direction (e.g., −X direction), and/or lower direction (e.g., −Y direction).

The state shown in FIG. 2 may be referred to as a closed state of the electronic device 101 or housing 210 and a slide-in state of the display 203.

The state shown in FIG. 3 may be referred to as an opened state of the electronic device 101 or housing 210 and a slide-out state of the display 203.

Referring to FIGS. 2 and 3, the electronic device 101 may include a housing 210. The housing 210 may include a first housing 202 and a second housing 202 disposed to be movable relative to the first housing 201. According to an embodiment, the electronic device 101 may be interpreted as having a structure in which the first housing 201 is disposed to be slidable with respect to the second housing 202. According to an embodiment, the second housing 202 may be disposed to perform reciprocating motion by a predetermined distance in a predetermined direction with respect to the first housing 201, for example, a direction indicated by an arrow \textcircled{1}.

According to an embodiment, the second housing 202 may be referred to as a slide portion or a slide housing, and may be movable relative to the first housing 201. According to an embodiment, the second housing 202 may receive various electrical/electronic components, such as a circuit board or a battery.

According to an embodiment, the first housing 202 may have, disposed therein, a motor, a speaker, a sim socket, and/or a sub circuit board electrically connected with a main circuit board. The second housing 201 may receive a main circuit board on which electric components, such as an application processor (AP) and a communication processor (CP) are mounted.

According to an embodiment, the first housing 201 may include a first cover member 211 (e.g., a main case). The first cover member 211 may include a 1-1th sidewall 211a, a 1-2th sidewall 211b extending from the 1-1th sidewall 211a, and a 1-3th sidewall 211c extending from the 1-1th sidewall 211a and substantially parallel to the 1-2th sidewall 211b. According to an embodiment, the 1-2th sidewall 211b and the 1-3th sidewall 211c may be formed substantially perpendicular to the 1-1th sidewall 211a.

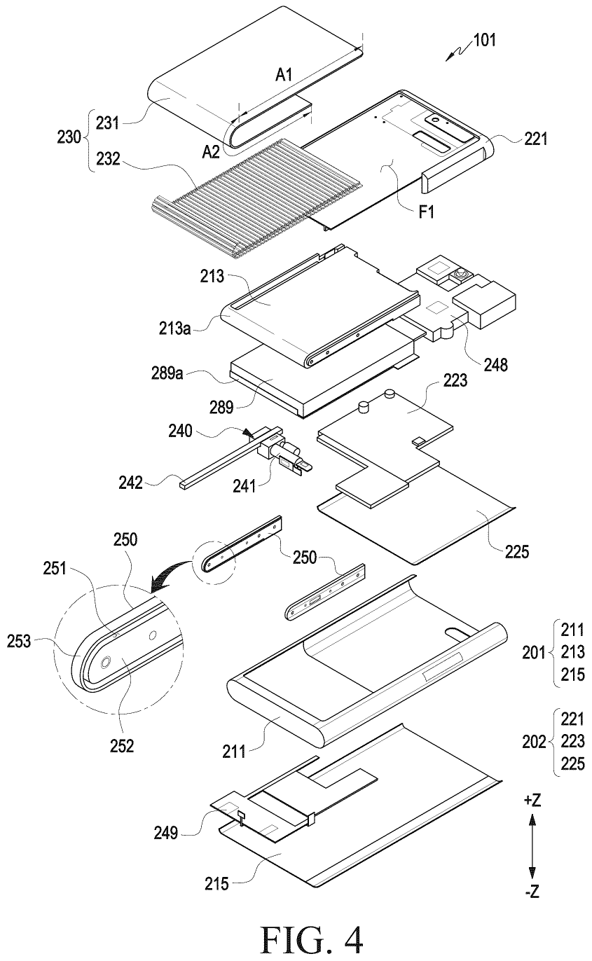

According to an embodiment, the 1-1th sidewall 211a, 1-2th sidewall 211b, and 1-3th sidewall 211c of the first cover member 211 may be formed to have a side opening (e.g., front opening) to receive (or surround) at least a portion of the second housing 202. For example, at least a portion of the second housing 202 may be surrounded by the first housing 201 and be slid in the direction parallel to the first surface (e.g., the first surface F1 of FIG. 4), e.g., arrow \textcircled{1} direction, while being guided by the first housing 201. According to an embodiment, the 1-1th sidewall 211a, the 1-2th sidewall 211b, and/or the 1-3th sidewall 211c of the first cover member 211 may be integrally formed. According to an embodiment, the 1-1th sidewall 211a, the 1-2th sidewall 211b, and/or the 1-3th sidewall 211c of the first cover member 211 may be formed as separate structures and be combined or assembled.

According to an embodiment, the first cover member 211 may be formed to surround at least a portion of the display 203. For example, at least a portion of the display 203 may be formed to be surrounded by the 1-1th sidewall 211a, the 1-2th sidewall 211b, and/or the 1-3th sidewall 211c of the first cover member 211.

According to an embodiment, the second housing 202 may include a second cover member 221 (e.g., a slide plate). The second cover member 221 may have a plate shape and include a first surface (e.g., the first surface F1 of FIG. 4) supporting internal components. For example, the second cover member 221 may support at least a portion of the display 203 (e.g., the first display area A1). According to an embodiment, the second cover member 221 may be referred to as a front cover.

According to an embodiment, the second cover member 221 may include a 2-1th sidewall 221a, a 2-2th sidewall 221b extending from the 2-1th sidewall 221a, and a 2-3th sidewall 221c extending from the 2-1th sidewall 221a and substantially parallel to the 2-2th sidewall 221b. According to an embodiment, the 2-2th sidewall 221b and the 2-3th sidewall 221c may be formed substantially perpendicular to the 2-1th sidewall 221a.

According to an embodiment, as the second housing 202 moves in a first direction (e.g., direction \textcircled{1}) parallel to the 1-2th sidewall 211b or the 1-2th sidewall 211c, the housing 210 may form an opened state and a closed state. In the closed state, the second housing 202 may be positioned at a first distance from the 1-1th sidewall 211a and, in the opened state, the second housing 202 may be moved to be positioned at a second distance larger than the first distance from the 1-1th sidewall 211a. In some embodiments, in the closed state, the first housing 201 may surround a portion of the 2-1th side wall 221a.

According to an embodiment, the electronic device 101 may include a display 203, a key input device 245, a connector hole 243, audio modules 247a and 247b, or camera modules 249a and 249b. According to an embodiment, the electronic device 101 may further include an indicator (e.g., a light emitting diode (LED) device) or various sensor modules.

According to an embodiment, the display 203 may include a first display area A1 configured to remain exposed and a second display area A2 configured to be exposed to the outside of the electronic device 101 based on the slide of the second housing 202. According to an embodiment, the first display area A1 may be disposed on the second housing 202. For example, the first display area A1 may be disposed on the second cover member 221 of the second housing 202. According to an embodiment, the second display area A2 may extend from the first display area A1, and as the second housing 202 slides relative to the first housing 201, the second display area A2 may be received in the first housing 201 (e.g., the slide-in state) or be visually exposed to the outside of the electronic device 101 (e.g., the slide-out state).

According to an embodiment, the second display area A2 may be received in the space positioned inside the first housing 201 or exposed to the outside of the electronic device while being substantially guided by one area (e.g., the curved surface 213a of FIG. 4) of the first housing 201. According to an embodiment, the second display area A2 may move based on a slide of the second housing 202 in the first direction (e.g., the direction indicated by the arrow \textcircled{1}. For example, while the second housing 202 slides, a portion of the second display area A2 may be deformed into a curved shape in a position corresponding to the curved surface 213a of the first housing 201.

According to an embodiment, when viewed from above the second cover member 221 (e.g., front cover), if the electronic device 210 changes from the closed state to opened state (e.g., if the second housing 202 slides to extend from the first housing 201), the second display area A2 may be gradually exposed to the outside of the first housing 201 and, together with the first display area A1, form a substantially flat surface. According to an embodiment, the display 203 may be coupled with or disposed adjacent to a touch detection circuit, a pressure sensor capable of measuring the strength (pressure) of touches, and/or a digitizer for detecting a magnetic field-type stylus pen. According to an embodiment, irrespective of the closed state or opened state of the housing 210, the exposed portion of the second display area A2 may be positioned on a portion (e.g., the curved surface 213a of FIG. 4) of the first housing, and a portion of the second display area A2 may remain in the curved shape in the position corresponding to the curved surface 213a.

According to an embodiment, the key input device 245 may be positioned in one area of the first housing 201. Depending on the appearance and the state of use, the electronic device 101 may be designed to omit the illustrated key input device 245 or to include additional key input device(s). According to an embodiment, the electronic device 101 may include a key input device (not shown), e.g., a home key button or a touchpad disposed around the home key button. According to an embodiment, at least a portion of the key input device 245 may be disposed on the 1-1th sidewall 211a, the 1-2th sidewall 211b, or the 1-3th sidewall 211c of the first housing 201.

According to an embodiment, the connector hole 243 may be omitted or may accommodate a connector (e.g., a universal serial bus (USB) connector) for transmitting and receiving power and/or data with an external electronic device. According to an embodiment (not shown), the electronic device 101 may include a plurality of connector holes 243, and some of the plurality of connector holes 243 may function as connector holes for transmitting/receiving audio signals with an external electronic device. In the illustrated embodiment, the connector hole 243 is disposed in the second housing 202, but is not limited thereto. For example, the connector hole 243 or a connector hole not shown may be disposed in the first housing 201.

According to an embodiment, the audio modules 247a and 247b may include at least one speaker hole 247a or at least one microphone hole 247b. One of the speaker holes 247a may be provided as a receiver hole for voice calls, and the other may be provided as an external speaker hole. The electronic device 101 may include a microphone for obtaining sound. The microphone may obtain external sound of the electronic device 101 through the microphone hole 247b. According to an embodiment, the electronic device 101 may include a plurality of microphones to detect the direction of sound. According to an embodiment, the electronic device 101 may include an audio module in which the speaker hole 247a and the microphone hole 247b are implemented as one hole or may include a speaker without the speaker hole 247a (e.g., a piezo speaker).

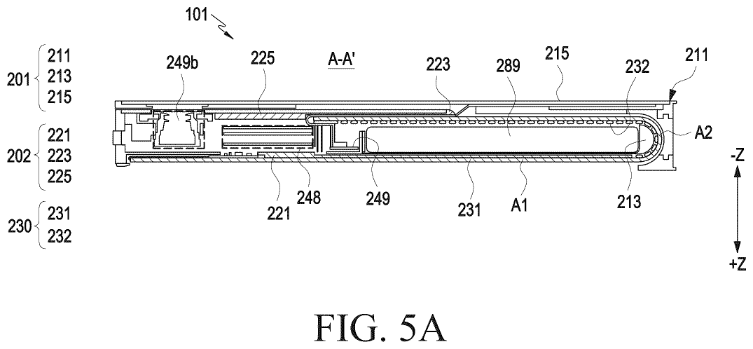

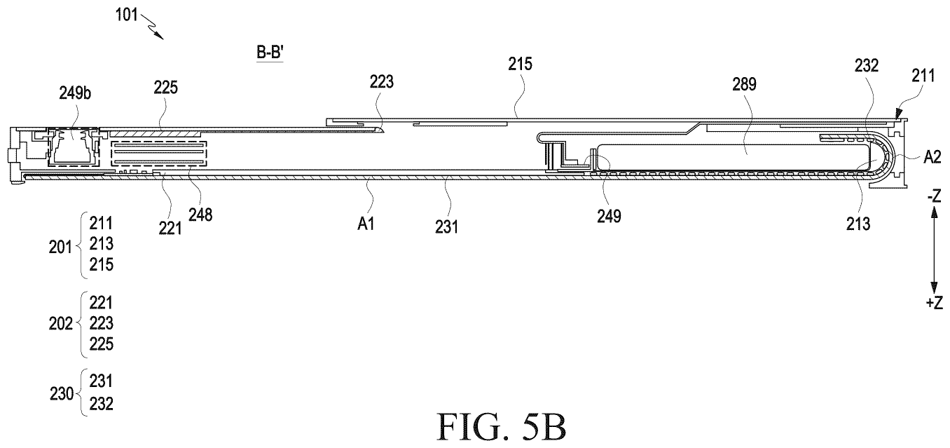

According to an embodiment, the camera modules 249a and 249b may include a first camera module 249a (e.g., a front camera) and a second camera module 249b (e.g., a rear camera) (e.g., the second camera module 249b of FIGS. 5A and 5B). According to an embodiment, the electronic device 101 may include at least one of a wide-angle camera, a telephoto camera, or a close-up camera. According to an embodiment, the electronic device 200 may measure the distance to the subject by including an infrared projector and/or an infrared receiver. The camera modules 249a and 249b may include one or more lenses, an image sensor, and/or an image signal processor. The first camera module 249a may be disposed to face in the same direction as the display 203. For example, the first camera module 249a may be disposed in an area around the first display area A1 or overlapping the display 203. When disposed in the area overlapping the display 203, the first camera module 249a may capture the subject through the display 203. According to an embodiment, the first camera module 249a may include an under display camera (UDC) that has a screen display area (e.g., the first display area A1) that may not be visually exposed but hidden. According to an embodiment, the second camera module 249b may capture the subject in a direction opposite to the first display area A1. According to an embodiment, the first camera module 249a and/or the second camera module 249b may be disposed on the second housing 202.

According to an embodiment, an indicator (not shown) of the electronic device 101 may be disposed on the first housing 201 or the second housing 202, and the indicator may include a light emitting diode to provide state information about the electronic device 101 as a visual signal. The sensor module (not shown) of the electronic device 101 may produce an electrical signal or data value corresponding to the internal operation state or external environment state of the electronic device. The sensor module may include, for example, a proximity sensor, a fingerprint sensor, or a biometric sensor (e.g., an iris/face recognition sensor or a heartrate monitor (HRM) sensor). According to another embodiment, the sensor module may further include, e.g., at least one of a gesture sensor, a gyro sensor, an atmospheric pressure sensor, a magnetic sensor, an acceleration sensor, a grip sensor, a color sensor, an infrared (IR) sensor, a temperature sensor, a humidity sensor, or an illuminance sensor.

FIG. 4 is an exploded perspective view illustrating an electronic device according to an embodiment.

FIG. 5A is a cross-sectional view taken along line A-A′ of FIG. 2 according to an embodiment.

FIG. 5B is a cross-sectional view taken along line B-B′ of FIG. 3 according to an embodiment.

Referring to FIGS. 4, 5A, and/or 5B, an electronic device 101 may include a first housing 201, a second housing 202, a display assembly 230, and a driving structure 240. The configuration of the first housing 201, the second housing 202, and the display assembly 230 of FIGS. 4, 5A, and/or 5B may be identical in whole or part to the configuration of the first housing 201, the second housing 202, and the display 203 of FIGS. 2 and/or 3.

According to an embodiment, the first housing 201 may include a first cover member 211 (e.g., the first cover member 211 of FIGS. 2 and 3), a frame 213, and a first rear plate 215.

According to an embodiment, the first cover member 211 may accommodate at least a portion of the frame 213 and accommodate a component (e.g., battery 289) positioned in the frame 213. According to an embodiment, the first cover member 211 may be formed to surround at least a portion of the second housing 202. According to an embodiment, the second circuit board 249 receiving the electronic component (e.g., the processor 120 and/or the memory 130 of FIG. 1) may be connected to the first cover member 211.

According to an embodiment, the frame 213 may be connected, directly or indirectly, to the first cover member 211. For example, the frame 213 may be connected to the first cover member 211. The second housing 202 is movable relative to the first cover member 211 and/or the frame 213. According to an embodiment, the frame 213 may accommodate the battery 289. According to an embodiment, the frame 213 may include a curved portion 213a facing the display assembly 230.

According to an embodiment, the first rear plate 215 may substantially form at least a portion of the exterior of the first housing 201 or the electronic device 101. For example, the first rear plate 215 may be coupled to the outer surface of the first cover member 221. According to an embodiment, the first rear plate 215 may provide a decorative effect on the exterior of the electronic device 101. The first rear plate 215 may be formed of at least one of metal, glass, synthetic resin, or ceramic.

According to an embodiment, the second housing 202 may include a second cover member 221 (e.g., the second cover member 221 of FIGS. 2 and 3), a rear cover 223, and a second rear plate 225.

According to an embodiment, the second cover member 221 may be connected to the first housing 201 through the guide rail 250 and, while being guided by the guide rail 250, reciprocate linearly in one direction (e.g., the direction of arrow \textcircled{1} in FIG. 3).

According to an embodiment, the second cover member 221 may support at least a portion of the display 203. For example, the second cover member 221 may include a first surface F1. The first display area A1 of the display 203 may be substantially positioned on the first surface F1 to maintain a flat panel shape. According to an embodiment, the second cover member 221 may be formed of a metal material and/or a non-metal (e.g., polymer) material. According to an embodiment, the first circuit board 248 accommodating the electronic component (e.g., the processor 120 and/or the memory 130 of FIG. 1) may be connected to the second cover member 221.

According to an embodiment, the rear cover 223 may protect a component (e.g., the first circuit board 248) positioned on the second cover member 221. For example, the rear cover 223 may be connected to the second cover member 221 and may be formed to surround at least a portion of the first circuit board 248. According to an embodiment, the rear cover 223 may include an antenna pattern for communicating with an external electronic device. For example, the rear cover 223 may include a laser direct structuring (LDS) antenna.

According to an embodiment, the second rear plate 225 may substantially form at least a portion of the exterior of the second housing 202 or the electronic device 101. For example, the second rear plate 225 may be coupled to the outer surface of the second cover member 221. According to an embodiment, the second rear plate 225 may provide a decorative effect on the exterior of the electronic device 101. The second rear plate 215 may be formed of at least one of metal, glass, synthetic resin, or ceramic.

According to an embodiment, the display assembly 230 may include a display 231 (e.g., the display 203 of FIGS. 2 and/or 3) and a multi-bar structure 232 supporting the display 203. According to an embodiment, the display 231 may be referred to as a flexible display, a foldable display, and/or a rollable display.

According to an embodiment, the multi-bar structure 232 may be connected to or attached to at least a portion (e.g., the second display area A2) of the display 231. According to an embodiment, as the second housing 202 slides, the multi-bar structure 232 may move with respect to the first housing 201. In the closed state of the electronic device 101 (e.g., FIG. 2), the multi-bar structure 232 may be mostly received in the first housing 201 and may be positioned between the first cover member 211 and the second cover member 221. According to an embodiment, at least a portion of the multi-bar structure 232 may move corresponding to the curved surface 213a positioned at the edge of the frame 213. According to an embodiment, the multi-bar structure 232 may be referred to as a display supporting member or supporting structure and may be in the form of one elastic plate.

According to an embodiment, the driving structure 240 may move the second housing 202 relative to the first housing 201. For example, the drive structure 240 may include a motor 241 configured to generate a driving force for sliding the housing 201 and 202. The driving structure 240 may include a gear (e.g., a pinion) connected to the motor 241 and a rack 242 configured to mesh with the gear.

According to an embodiment, the housing in which the rack 242 is positioned and the housing in which the motor 241 is positioned may be different. According to an embodiment, the motor 241 may be connected to the second housing 202. The rack 242 may be connected to the first housing 201. According to another embodiment, the motor 241 may be connected to the first housing 201. The rack 242 may be connected to the second housing 202.

According to an embodiment, the first housing 201 may receive the first circuit p board 248 (e.g., a main board). According to an embodiment, the processor, memory, and/or interface may be mounted on the first circuit board 248. The processor may include one or more of, e.g., a central processing unit, an application processor, a graphic processing device, an image signal processing, a sensor hub processor, or a communication processor. According to an embodiment, the first circuit board 248 may include a flexible printed circuit board type radio frequency cable (FRC). The first circuit board 248 may be disposed on at least a portion of the second cover member 221 and may be electrically connected to the antenna module and the communication module.

According to an embodiment, the memory may include, e.g., a volatile or non-volatile memory.

According to an embodiment, the interface may include, e.g., a high definition multimedia interface (HDMI), a universal serial bus (USB) interface, a secure digital (SD) card interface, and/or an audio interface. The interface may electrically or physically connect, e.g., the electronic device 101 with an external electronic device and may include a USB connector, an SD card/multimedia card (MMC) connector, or an audio connector.

According to an embodiment, the electronic device 101 may include a second circuit board 249 (e.g., a sub circuit board) spaced apart from the first circuit board 248 (e.g., a main circuit board) in the first housing 201. The second circuit board 249 may be electrically connected to the first circuit board 248 through a connection flexible board. The second circuit board 249 may be electrically connected with electric components disposed in an end area of the electronic device 101, such as the battery 289 or a speaker and/or a sim socket, and may transfer signals and power. According to an embodiment, the second circuit board 249 may receive a wireless charging antenna (e.g., coil). For example, the battery 289 may receive power from an external electronic device through the wireless charging antenna. As another example, the battery 289 may transfer power to the external electronic device by the wireless charging antenna.

According to an embodiment, the battery 289 may be a device for supplying power to at least one component of the electronic device 101. The battery 189 may include a primary cell which is not rechargeable, a secondary cell which is rechargeable, or a fuel cell. The battery 289 may be integrally or detachably disposed inside the electronic device 101. According to an embodiment, the battery 289 may be formed of a single embedded battery or may include a plurality of removable batteries. According to an embodiment, the battery 289 may be positioned in a frame 213, and the battery 289 may be slid along with the frame 213.

According to an embodiment, the guide rail 250 may guide the movement of the multi-bar structure 232. For example, the multi-bar structure 232 may slide along the slit 251 formed in the guide rail 250. According to an embodiment, the guide rail 250 may be connected to the first housing 201. For example, the guide rail 250 may be connected to the first cover member 211 and/or the frame 213. According to an embodiment, the slit 251 may be referred to as a groove or recess formed in the inner surface of the guide rail 250.

According to an embodiment, the guide rail 250 may provide pressure to the multi-bar structure 233 based on the driving of the motor 241.

According to an embodiment, when the electronic device 101 changes from the closed state to opened state, the inner portion 252 of the guide rail 250 may provide pressure to the multi-bar structure 232. The multi-bar structure 232 receiving the pressure may be moved along the slit 251 of the guide rail 250, and the second housing 202 may be changed from the slide-in state to slide-out state with respect to the first housing 201. At least a portion of the display assembly 230 accommodated between the first cover member 211 and the frame 213 may be extended to the front surface.

According to an embodiment, when the electronic device 101 changes from the opened state to closed state, an outer portion 253 of the guide rail 250 may provide pressure to the bent multi-bar structure 232. The multi-bar structure 232 receiving the pressure may be moved along the slit 251 of the guide rail 250, and the second housing 202 may be changed from the slide-out state to slide-in state with respect to the first housing 201. At least a portion of the display assembly 230 may be accommodated between the first cover member 211 and the frame 213.

Referring to FIG. 5A, in the closed state of the electronic device 101, at least a portion of the second housing 202 may be disposed to be received in the first housing 201. As the second housing 202 is disposed to be received in the first housing 201, the overall volume of the electronic device 101 may be reduced. According to an embodiment, when the second housing 202 is received in the first housing 201, the size of the visually exposed display 231 may be minimized or reduced. For example, if the second housing 202 is fully received in the first housing 201, the first display area A1 of the display 231 may be visually exposed, and the second display area A2 may not be visually exposed. At least a portion of the second display area A2 may be disposed between the battery 289 and the rear plate 215 and 225.

Referring to FIG. 5B, in the opened state of the electronic device 101, at least a portion of the second housing 202 may protrude from the first housing 201. As the second housing 202 is disposed to protrude from the first housing 201, the overall volume of the electronic device 101 may be increased. According to an embodiment, if the second housing 202 protrudes from the first housing 201, at least a portion of the second display area A2 of the display 231, together with the first display area A1, may be visually exposed to the outside of the electronic device 101.

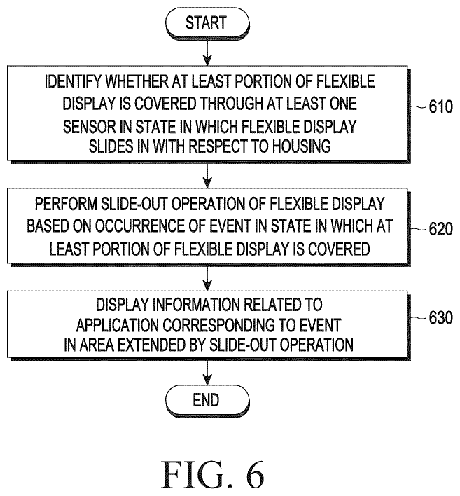

FIG. 6 is a flowchart illustrating an extending operation when an event occurs in a state in which at least a portion of a flexible display of an electronic device is covered according to an embodiment.

Referring to FIG. 6, in operation 610, the electronic device (e.g., the electronic device 101 of FIG. 1, the processor 120 of FIG. 1) may identify whether at least a portion of the flexible display is covered through at least one sensor (e.g., the sensor module 176 of FIG. 1) in a state in which the display module 160 of FIG. 1 slides in with respect to the housing.

According to an embodiment, the electronic device may identify that at least a portion of the flexible device is covered based on identifying that the flip cover is closed through at least one sensor (e.g., a proximity sensor, an illumination sensor, and/or a hall IC sensor). According to an embodiment, the flip cover may be fastened to a portion of the housing of the electronic device to cover at least a portion of the surface of the flexible display. According to an embodiment, even when at least a portion of the flexible display is covered by not only the flip cover but also a pocket-shaped cover, the user's hand and/or an object, the electronic device may identify that at least a portion of the flexible device is covered through at least one sensor.

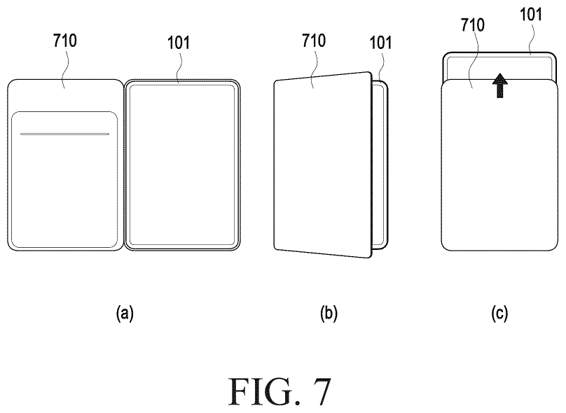

According to an embodiment, when the flip cover is fastened to the electronic device, an example of using the electronic device is described in more detail with reference to FIG. 7.

According to an embodiment, in operation 620, the electronic device may perform a slide-out operation of the flexible display based on an occurrence of an event in a state in which at least a portion of the flexible display is covered.

According to an embodiment, the electronic device may perform a slide-out operation of the flexible display stepwise or continuously.

For example, the electronic device may be extended by a second size by a user input in a state in which the flexible display is extended by a first size, and be extended by a third size in a state in which the flexible display is extended by the second size.

According to an embodiment, when a user input for extending the flexible display is continuously received (e.g., when a physical key for extension is long pressed), the electronic device may continuously extend the flexible display.

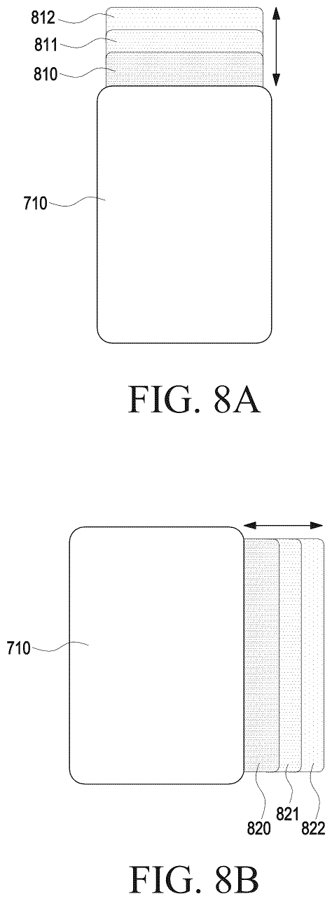

According to an embodiment, an operation of extending the flexible display is described below with reference to FIGS. 8A and 8B.

According to an embodiment, in operation 630, the electronic device may display information related to the event in the area extended by the slide-out operation.

According to an embodiment, the electronic device may determine an extension size of the flexible display based on an application corresponding to the event. According to an embodiment, the extension size of the flexible display according to the application may be set by the manufacturer and/or the user. For example, the flexible display may be configured to be extended by a first size for a music player application, by a second size larger than the first size for a message application and/or a first SNS application, and by a third size larger than the second size for a video player application, a second SNS application, or a camera application.

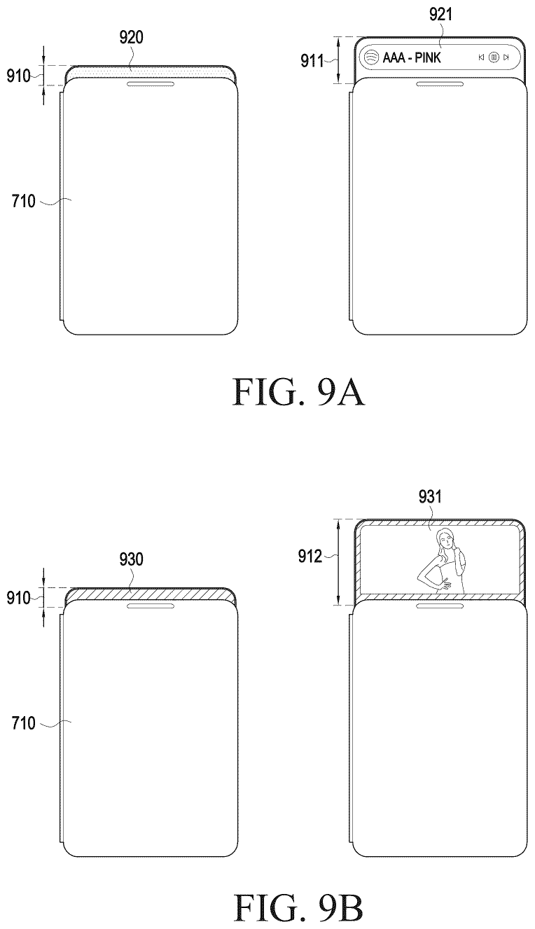

According to an embodiment, an operation of extending the flexible display based on the application corresponding to the generated event is described below with reference to FIGS. 9A and 9B.

According to an embodiment, the electronic device may gradually extend the flexible display based on a user input after the event occurs.

According to an embodiment, the electronic device may perform a slide-out operation of the flexible display so that the flexible display is extended by the first size based on the occurrence of the event. According to an embodiment, the electronic device may display a color corresponding to an application corresponding to the event in an extended area having the first size. According to an embodiment, the color corresponding to the application may be a main color of an application icon.

According to an embodiment, the electronic device may perform the slide-out operation of the flexible display so that the flexible display is extended by the second size larger than the first size based on receiving the user input for display extension in a state in which the flexible display is extended by the first size. For example, the electronic device may perform the slide-out operation of the flexible display so that the flexible display is extended by the second size larger than the first size when the extended area of the flexible display is touched or a physical key for extending the flexible display is pressed in a state in which the flexible display is extended by the first size.

According to an embodiment, the electronic device may display information related to the event corresponding to the second size in the extended area of the second size. According to an embodiment, the electronic device may display a user interface capable of controlling content and/or summary of content related to the event in the extended area having the second size.

According to an embodiment, the electronic device may divide the extended area of the second size into a left area and a right area, and display different information related to the event in the divided areas. According to an embodiment, when the second size is larger than or equal to a set value and the event-related application includes a function of displaying an image and/or a video, the electronic device may divide the extended area having the second size into a left area and a right area, display a user interface capable of controlling content and/or summary of content related to the event in one area, and display an image and/or video (e.g., a visual interface (VI)) of the application in the other area.

According to an embodiment, if the flexible display is configured to display a widget when its size is the second size or more, the electronic device may display a widget in one of the divided areas and display a summary of content related to the event, a user interface capable of controlling content and/or an image (or video) of the application in the other area.

According to an embodiment, the electronic device may perform a slide-out operation of the flexible display so that the flexible display is extended by the third size larger than the second size based on receiving a user input in a state in which the flexible display is extended by the second size. For example, the electronic device may perform the slide-out operation of the flexible display so that the flexible display is extended by the third size larger than the second size when the extended area of the flexible display is touched or a physical key for extending the flexible display is pressed in a state in which the flexible display is extended by the second size.

According to an embodiment, the electronic device may display information related to the event corresponding to the third size in the extended area having the third size. According to an embodiment, the electronic device may display a user interface capable of controlling content and/or at least a portion of the entire content related to the event in the extended area having the third size.

According to an embodiment, the electronic device may divide the extended area having the third size into an upper area and a lower area, and display different information related to the event in the divided areas. According to an embodiment, when the third size is larger than or equal to a set value and the event-related application includes a function of displaying an image and/or a video, the electronic device may divide the extended area having the third size into an upper area and a lower area, display a user interface capable of controlling content and/or at least a portion of content related to the event in one area, and display an image and/or video (e.g., a visual interface (VI)) of the application in the other area.

According to an embodiment, if the flexible display is configured to display a widget when its size is the third size or more, the electronic device may display a widget in one of the divided areas and display at least a portion of content related to the event, a user interface capable of controlling content and/or an image (or video) of the application in the other area.

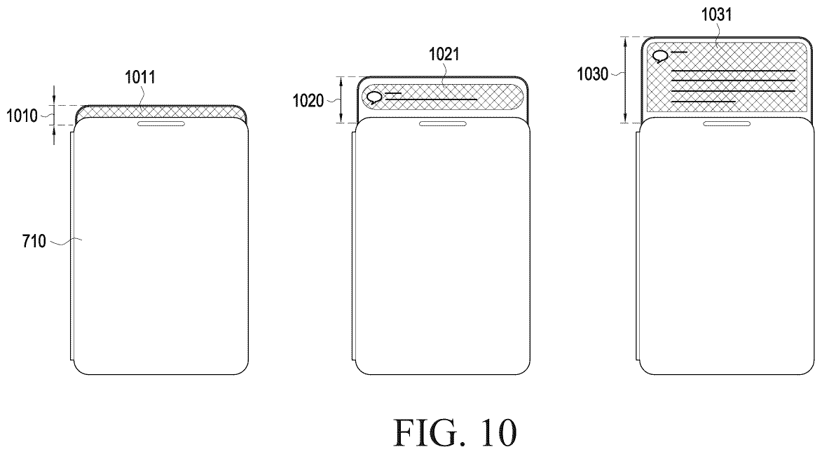

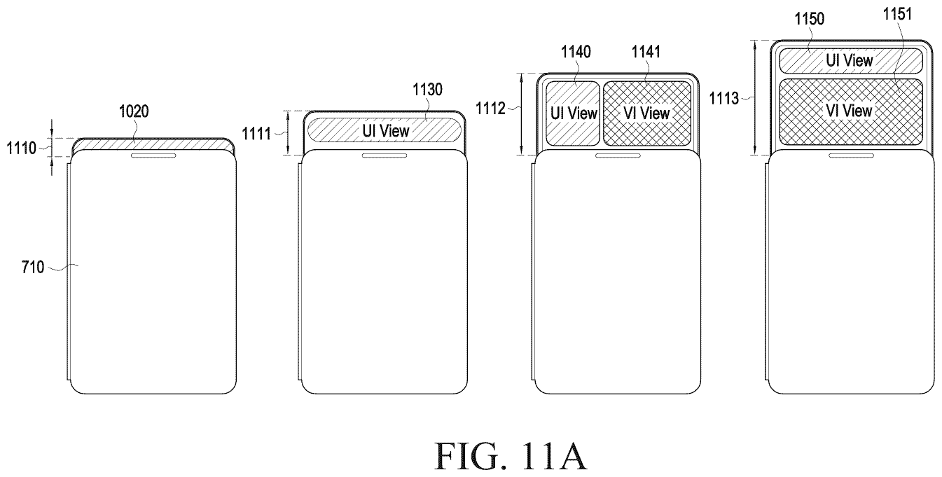

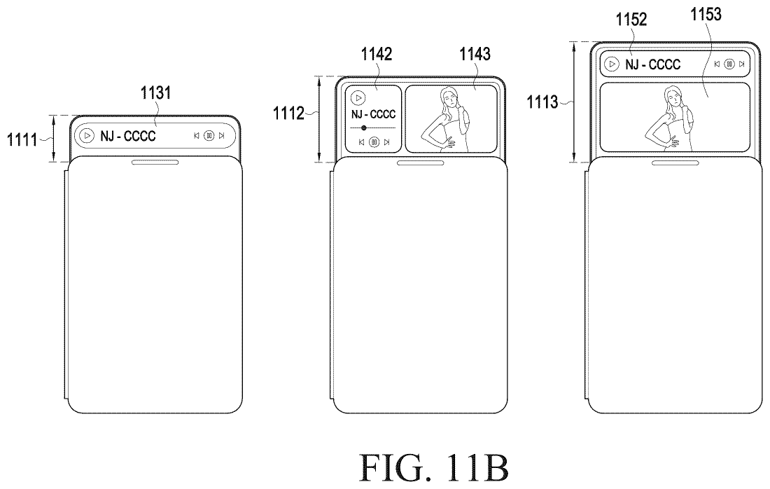

According to an embodiment, an operation of extending the flexible display based on a user input and an operation of dividing the screen according to the size of the extended area are described in more detail with reference to FIGS. 10, 11A, and 11B.

According to an embodiment, the electronic device may display a live view obtained by a camera (e.g., the camera module 180 of FIG. 1) in the extended area based on an event being the execution of the camera application.

According to an embodiment, if a user input for capturing is received, the electronic device may obtain an image (or video) having the same aspect ratio as the extended area.

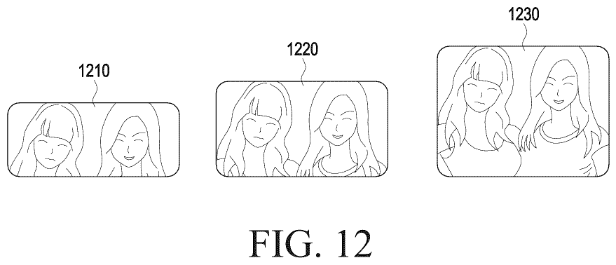

According to an embodiment, an operation of obtaining an image (or video) having the same aspect ratio as the aspect ratio of the extended area of the flexible display is described with reference to FIG. 12.

According to an embodiment, the electronic device may display a preset widget in at least a portion of the extended area of the flexible display. According to an embodiment, when the flexible display is extended, the displayed widget may be set by a user input.

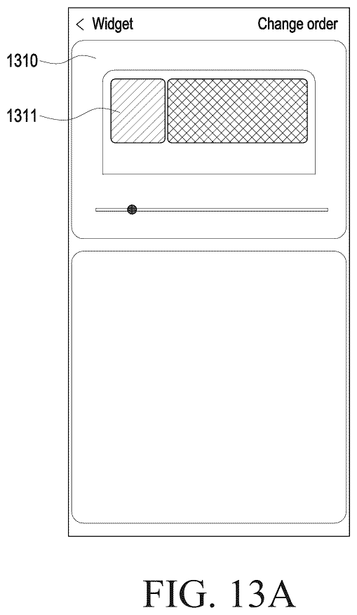

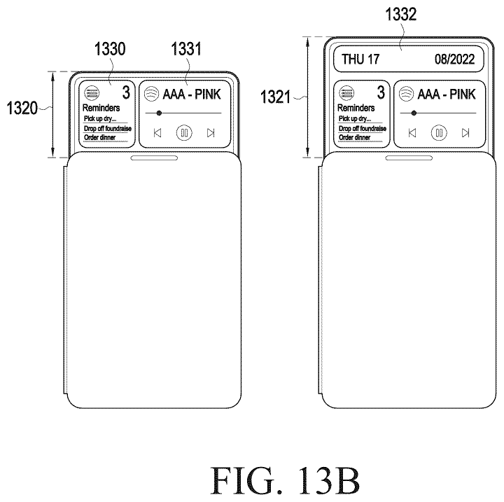

According to an embodiment, an operation of displaying a widget in an extended area of the flexible display is described below in more detail with reference to FIGS. 13A and 13B.

FIG. 7 is a view illustrating a use example when an electronic device is mounted on a flip cover according to an embodiment. For example, FIG. 7(a) illustrates a state in which the flip cover is opened, FIG. 7(b) illustrates a state in which the flip cover is partially closed, and FIG. 7(c) illustrates a state in which the flexible display is extended in a state in which the flip cover is closed.

According to an embodiment, at least a portion of the housing of the electronic device 101 (e.g., the electronic device 101 of FIG. 1) may be fastened to the flip cover 710. According to an embodiment, the flip cover 710 may include a cover covering the flexible display (e.g., the display module 160 of FIG. 1) of the electronic device 101. According to an embodiment, a transparent material may be disposed in at least a partial area of the cover of the flip cover 710. According to an embodiment, a card receiving portion may be disposed in at least a partial area of the flip cover 710.

According to an embodiment, as illustrated in FIG. 7(a), in the opened state of the flip cover 710, the flexible display is not covered, and even when the flexible display is extended, not only the extended area but also the existing area may be used without disturbance.

According to an embodiment, as illustrated in FIG. 7(b), in the at least partially closed state in which the cover of the flip cover 710 is rotated to cover at least a portion of the flexible display of the electronic device 101, the electronic device 101 may detect that the flip cover 710 is at least partially closed through at least one sensor (e.g., the sensor module 176 of FIG. 1).

According to an embodiment, as illustrated in FIG. 7(c), in a case where the flip cover 710 is closed in a state in which the flexible display of the electronic device 101 is slid in, if an event occurs, the electronic device 101 may extend the flexible display and display information related to the event in the extended area outside the flip cover 710.

As such, event notification and user interaction are possible even when the flip cover is in the closed state.

FIG. 8A is a view illustrating an operation of extending a flexible display of an electronic device in a vertical direction in a state in which at least a portion thereof is covered according to an embodiment.

FIG. 8B is a view illustrating an operation of extending a flexible display of an electronic device in a horizontal direction in a state in which at least a portion thereof is covered according to an embodiment.

Referring to FIGS. 8A and 8B, if an event occurs in a state in which the flip cover 710 is closed, the electronic device (e.g., the electronic device 101 of FIG. 1 or the processor 120 of FIG. 1) may extend the flexible display (e.g., the display module 160 of FIG. 1) to a first size 810 and 820 (e.g., 30% of the maximum extendable size), a second size 811 and 821 (e.g., 50% of the maximum extendable size), and/or a third size 812 and 822 (e.g., the maximum extendable size) larger than the second size 811 and 821.

According to an embodiment, the electronic device may extend the flexible display to a size set for each application in which an event occurs.

According to an embodiment, the electronic device may gradually or continuously extend the flexible display to the first size 810 and 820, the second size 811 and 821, or the third size 812 and 822, according to a user input. For example, in a case where the flexible display is extended to the first size 810 or 820 based on an occurrence of an event, if a user input (e.g., pressing a physical key for extending the flexible display or touching the extended area) is received, the electronic device may extend the flexible display to the second size 811 and 821.

According to an embodiment, if a user input for extending the flexible display is received in a state in which the flexible display is extended to the second size 811 and 821, the electronic device may extend the flexible display to the third size 821 and 831.

Although three extension sizes of the flexible display are illustrated and described in FIGS. 8A and 8B, according to an embodiment, there may be two or less, or four or more extension sizes of the flexible display.

According to an embodiment, when the flexible display is extended to the first size 810 and 820 based on the occurrence of an event, if the user input for extending the flexible display (e.g., pressing a physical key for extending the flexible display or touching the extended area) is maintained (e.g., long press or long touch), the electronic device may continuously extend the flexible display until the user input is completed.

According to an embodiment, vertical extension of the flexible display is illustrated and described in FIGS. 9A to 13B, but the operations of the electronic device illustrated in FIGS. 9A to 13B are applicable even when the flexible display is extended in a horizontal direction.

FIG. 9A is a view illustrating an extending operation based on an application where an event occurs, in a state in which at least a portion of a flexible display of an electronic device is covered according to an embodiment. For example, FIG. 9A illustrates a case where an event occurs in a music player application.

Referring to FIG. 9A, if an event occurs in a state in which the flip cover 710 is closed, the electronic device (e.g., the electronic device 101 of FIG. 1 or the processor 120 of FIG. 1) may extend the flexible display (e.g., the display module 160 of FIG. 1) by the first size 910 and display information 920 about the event corresponding to the first size 910 in which the event occurs in the extended area having the first size 910. According to an embodiment, the information 920 about the event displayed in the extended area having the first size 910 may be a color corresponding to the application in which the event has occurred. According to an embodiment, the color corresponding to the application may be a main color (e.g., green) of the icon of the application.

According to an embodiment, if a user input for extending the flexible display (e.g., pressing a physical key for extending the flexible display or touching the extended area) is received in a state in which the flexible display is extended to the first size 910, the electronic device may extend the flexible display to the second size 911 corresponding to the application in which the event has occurred.

According to an embodiment, the electronic device may display information 921 about the event corresponding to the second size 911 on the flexible display extended to the second size 911. According to an embodiment, the information 921 about the event corresponding to the second size 911 may include a summary for content and/or a user interface (e.g., information about the music being played (song title and/or singer), playback/pause button, previous song button, and next song button) for content control.

FIG. 9B is a view illustrating an extending operation based on an application where an event occurs, in a state in which at least a portion of a flexible display of an electronic device is covered according to an embodiment. For example, FIG. 9B illustrates a case where an event occurs in a video player application.

Referring to FIG. 9B, if an event occurs in a state in which the flip cover 710 is closed, the electronic device may extend the flexible display by the first size 910 and display information 930 about the event corresponding to the first size 910 in the extended area having the first size 910. According to an embodiment, the information 930 about the application displayed in the extended area having the first size 910 may be a color corresponding to the application in which an event has occurred. According to an embodiment, the color corresponding to the application may be a main color (e.g., red) of the icon of the application.

According to an embodiment, if a user input for extending the flexible display (e.g., pressing a physical key for extending the flexible display or touching the extended area) is received in a state in which the flexible display is extended to the first size 910, the electronic device may extend the flexible display to the third size 912 corresponding to the application in which the event has occurred.

According to an embodiment, the electronic device may display information 931 about the event corresponding to the third size 912 on the flexible display extended to the third size 912. According to an embodiment, the information 931 about the event corresponding to the third size 912 may include content (e.g., video) about the content.

As such, in a state in which the flip cover 710 is closed, a different color may be displayed and the flexible display may be extended to a different size according to the application in which the event occurs.

FIG. 10 is a view illustrating a stepwise extending operation when an event occurs in a state in which at least a portion of a flexible display of an electronic device is covered according to an embodiment.

Referring to FIG. 10, if an event occurs in a state in which the flip cover 710 is closed, the electronic device (e.g., the electronic device 101 of FIG. 1 or the processor 120 of FIG. 1) may extend the flexible display (e.g., the display module 160 of FIG. 1) by the first size and display information 1011 about the event corresponding to the first size 1010 in the extended area having the first size 1010. According to an embodiment, the information 1011 about the event displayed in the extended area having the first size 1010 may be a color corresponding to the application in which the event has occurred. According to an embodiment, the color corresponding to the application may be a main color (e.g., yellow) of the icon of the application.

According to an embodiment, if a user input for extending the flexible display (e.g., pressing a physical key for extending the flexible display or touching the extended area) is received in a state in which the flexible display is extended to the first size 1010, the electronic device may extend the flexible display to the second size 1020 corresponding to the application in which the event has occurred.

According to an embodiment, the electronic device may display information 1021 about the event corresponding to the second size 1020 on the flexible display extended to the second size 1020. According to an embodiment, the information 1021 about the event corresponding to the second size 1020 may include a summary (e.g., a new message arrival notification) of the content and/or a user interface for controlling the content.

According to an embodiment, if a user input for extending the flexible display (e.g., pressing a physical key for extending the flexible display or touching the extended area) is received in a state in which the flexible display is extended to the second size 1020, the electronic device may extend the flexible display to the third size 1030 corresponding to the application in which the event has occurred.

According to an embodiment, the electronic device may display information 1031 about the event corresponding to the third size 1030 on the flexible display extended to the third size 1030. According to an embodiment, the information 1031 about the event corresponding to the third size 1030 may include content (e.g., message content) about the content.

Although FIG. 10 illustrates that the flexible display is extended stepwise and information corresponding to the size of the extended area is displayed, according to an embodiment, when the user input is continuous (e.g., a long press on a physical key or a long touch on the flexible display), the electronic device may extend the flexible display until the user input is completed and display information about the event corresponding to the size of the extended flexible display.

As such, notification of the occurrence of an event and user interaction are possible even when the flip cover is closed.

FIG. 11A is a view illustrating an operation in which a screen configuration is varied during stepwise extension in a state in which at least a portion of a flexible display of an electronic device is covered according to an embodiment.

FIG. 11B is a view illustrating an operation in which a screen configuration is varied during stepwise extension in a state in which at least a portion of a flexible display of an electronic device is covered according to an embodiment.

Referring to FIG. 11A, if an event occurs in a state in which the flip cover 710 is closed, the electronic device (e.g., the electronic device 101 of FIG. 1 or the processor 120 of FIG. 1) may extend the flexible display (e.g., the display module 160 of FIG. 1) by the first size and display information 1120 about the event corresponding to the first size 1110 in the extended area having the first size 1110. According to an embodiment, the information 1120 about the event displayed in the extended area having the first size 1110 may be a color corresponding to the application in which the event has occurred. According to an embodiment, the color corresponding to the application may be a main color of the application icon.

According to an embodiment, if a user input for extending the flexible display (e.g., pressing a physical key for extending the flexible display or touching the extended area) is received in a state in which the flexible display is extended to the first size 1110, the electronic device may extend the flexible display to the second size 1111 corresponding to the application in which the event has occurred.

According to an embodiment, the electronic device may display information 1130 about the event corresponding to the second size 1111 on the flexible display extended to the second size 1111. According to an embodiment, the information 1130 about the event corresponding to the second size 1111 may include a summary of content and/or a user interface for content control. For example, as illustrated in FIG. 11B, information 1131 about the event corresponding to the second size 1111 may include information about the song being played (song title and/or singer), a play/pause button, a previous song button, and/or a next song button.

According to an embodiment, if a user input for extending the flexible display (e.g., pressing a physical key for extending the flexible display or touching the extended area) is received in a state in which the flexible display is extended to the second size 1111, the electronic device may extend the flexible display to the third size 1112 corresponding to the application in which the event has occurred.

According to an embodiment, the electronic device may divide the extended area having the third size 1112 into a left area and a right area, display a summary of content related to the event and/or a user interface (UI) capable of controlling content in one area 1140, and display an image and/or video (e.g., a visual interface (VI)) of the application in the other area 1141.

For example, as illustrated in FIG. 11B, the electronic device may display information about the song being played (song title and/or singer), playback/pause button, previous song button, and/or next song button) in one area 1142 of the divided left and right areas of the extended area having the third size 1112 of the flexible display, and display an image or video related to the song being played in the other area 1143.

According to an embodiment, if a user input for extending the flexible display (e.g., pressing a physical key for extending the flexible display or touching the extended area) is received in a state in which the flexible display is extended to the third size 1112, the electronic device may extend the flexible display to a fourth size 1113 corresponding to the application in which the event has occurred.

According to an embodiment, the electronic device may divide the extended area having the fourth size 1113 into an upper area and a lower area and display different information related to the event in the divided areas. A summary of content related to the event and/or a user interface (UI) capable of controlling content may be displayed in one area 1150, and an image and/or video (e.g., a visual interface (VI)) of the application may be displayed in the other area 1151.

For example, as illustrated in FIG. 11B, the electronic device may display information about the song being played (song title and/or singer), playback/pause button, previous song button, and/or next song button) in one area 1152 of the divided upper and lower areas of the extended area having the fourth size 1113 of the flexible display, and display an image or video related to the song being played in the other area 1153.

By differently arranging the divided areas based on the extension size of the flexible display as described above, information including an image and/or a video may be provided more efficiently.

FIG. 12 is a view illustrating an operation of obtaining an image based on an aspect ratio of an extended area when a camera application is executed in a state in which at least a portion thereof a flexible display of an electronic device is covered according to an embodiment.

Referring to FIG. 12, if an event of executing a camera application occurs in a state in which the flip cover 710 is closed, the electronic device (e.g., the electronic device 101 of FIG. 1 or the processor 120 of FIG. 1) may extend the flexible display (e.g., the display module 160 of FIG. 1) by the first size and display a live view obtained by the camera (e.g., the camera module 180 of FIG. 1) in the extended area having the first size. According to an embodiment, the camera may be a rear camera or a front camera of the electronic device.

According to an embodiment, if a user input for capturing is received in a state in which a live view is displayed on the flexible display extended to the first size, the electronic device may obtain an image 1210 (or video) having the same aspect ratio as the first size.

According to an embodiment, when the flexible display is extended by a second size larger than the first size based on receiving a user input (e.g., pressing a physical key for extending the flexible display or touching a user interface touch of the flexible display), the electronic device may display a live view obtained by the camera in the extended area having the second size.

According to an embodiment, if a user input for capturing is received in a state in which a live view is displayed on the flexible display extended to the second size, the electronic device may obtain an image 1220 (or video) having the same aspect ratio as the second size.

According to an embodiment, when the flexible display is extended by a third size larger than the second size based on receiving a user input (e.g., pressing a physical key for extending the flexible display or touching a user interface of the flexible display), the electronic device may display a live view obtained by the camera in the extended area having the third size.

According to an embodiment, if a user input for capturing is received in a state in which a live view is displayed on the flexible display extended to the third size, the electronic device may obtain an image 1230 (or video) having the same aspect ratio as the third size.

FIG. 13A is a view illustrating a configuration screen for receiving a user input for setting to display a widget when a flexible display is extended based on an occurrence of an event in a state in which at least a portion of a flexible display of an electronic device is covered according to an embodiment.

Referring to FIG. 13A, the electronic device (e.g., the electronic device 101 of FIG. 1 or the processor 120 of FIG. 1) may display a setting screen 1310 for setting a widget to be displayed in the extended area when the flexible display (e.g., the display module 160 of FIG. 1) is extended in a state in which the flip cover (e.g., the flip cover 710 of FIG. 7) is closed. According to an embodiment, a user input for setting the widget 1311 to be

displayed in the extended area may be received through the setting screen 1310. According to an embodiment, the application to be displayed as the widget, the type of the widget, the position where the widget is to be displayed, and/or the size of the widget may be set through the setting screen 1310.

According to an embodiment, a different widget may be set for each size of the extended area through the setting screen 1310.

FIG. 13B is a view illustrating a widget displayed based on a degree of extension of a flexible display in a state in which at least a portion of a flexible display of an electronic device is covered according to an embodiment.

Referring to FIG. 13B, the electronic device may extend the flexible display by the first size 1320 based on the occurrence of an event in a state in which the flip cover (e.g., the flip cover 710 of FIG. 7) is closed, and display information about the event corresponding to the first size 1320 in the extended area having the first size 1320.

According to an embodiment, based on the setting of the electronic device, the electronic device may divide the extended area having the first size 1320 into a left area and a right area, display a widget 1330 disposed by a user input in one area 1330, and display a summary of content related to the event and/or a user interface capable of controlling content in the other area 1331.

According to an embodiment, based on receiving a user input for extending the flexible display in a state in which the flexible display is extended by the first size 1320, the flexible display may be extended by a second size 1321 larger than the first size 1320.

According to an embodiment, the electronic device may further display a second widget 1332 disposed by a user input in the area extended further than the first size of the extended area having the second size 1321.

As described above, even when the flip cover is closed, interaction with the user may be possible through extension of the flexible display.

According to an embodiment, an electronic device may comprise a housing, at least one sensor, a flexible display at least partially exposed to an outside through the housing, and at least one processor operatively connected, directly or indirectly, to the at least one sensor and the flexible display.

According to an embodiment, the at least one processor may identify whether at least a portion of the flexible display is covered through the at least one sensor in a state in which the flexible display slides in with respect to the housing.

According to an embodiment, the at least one processor may perform a slide-out operation of the flexible display based on an occurrence of an event in the state in which the at least a portion of the flexible display is covered.

According to an embodiment, the at least one processor may display information related to the event in an area extended by the slide-out operation.

According to an embodiment, the at least one processor may identify that the at least a portion of the flexible display is covered based on identifying that a flip cover is closed through the at least one sensor.

According to an embodiment, the at least one processor may perform the slide-out operation of the flexible display to extend the flexible display by a first size based on the occurrence of the event.

According to an embodiment, the at least one processor may display a color corresponding to an application corresponding to the event in the extended area having the first size.

According to an embodiment, the at least one processor may perform the slide-out operation of the flexible display to extend the flexible display by a second size larger than the first size based on receiving a user input in a state in which the flexible display is extended by the first size.

According to an embodiment, the at least one processor may display information related to the event corresponding to the second size in the extended area having the second size.

According to an embodiment, the at least one processor may divide the extended area having the second size into a left area and a right area.

According to an embodiment, the at least one processor may display different information related to the event in the divided areas.

According to an embodiment, the at least one processor may perform the slide-out operation of the flexible display to extend the flexible display by a third size larger than the second size based on receiving a user input in a state in which the flexible display is extended by the second size.

According to an embodiment, the at least one processor may display information related to the event corresponding to the third size in the extended area having the third size.

According to an embodiment, the at least one processor may divide the extended area having the third size into an upper area and a lower area.

According to an embodiment, the at least one processor may display different information related to the event in the divided areas.

According to an embodiment, the at least one processor may determine an extension size of the flexible display based on the application corresponding to the event.

According to an embodiment, the electronic device may further comprise a camera.

According to an embodiment, the at least one processor may display a live view obtained by the camera in the extended area based on the event being execution of a camera application.

According to an embodiment, the at least one processor may obtain an image having the same aspect ratio as an aspect ratio of the extended area if a user input for capturing is received.

According to an embodiment, the at least one processor may display a preset widget in at least a portion of the extended area.

According to an embodiment, a method for controlling an electronic device may comprise identifying whether at least a portion of a flexible display is covered through at least one sensor in a state in which the flexible display slides in with respect to a housing.

According to an embodiment, the method for controlling the electronic device may comprise sliding out the flexible display based on an occurrence of an event in the state in which the at least a portion of the flexible display is covered.

According to an embodiment, the method for controlling the electronic device may comprise displaying information related to the event in an area extended by the slide-out operation.

According to an embodiment, identifying that the at least a portion of the flexible display is covered may identify that the at least a portion of the flexible display is covered based on identifying that a flip cover is closed through the at least one sensor.

According to an embodiment, sliding out the flexible display may slide out the flexible display to extend the flexible display by a first size based on the occurrence of the event.

According to an embodiment, displaying the information related to the event may display a color corresponding to an application corresponding to the event in the extended area having the first size.

According to an embodiment, the method for controlling the electronic device may further comprise sliding out the flexible display to extend the flexible display by a second size larger than the first size based on receiving a user input in a state in which the flexible display is extended by the first size.

According to an embodiment, the method for controlling the electronic device may further comprise displaying information related to the event corresponding to the second size in the extended area having the second size.

According to an embodiment, displaying the information related to the event corresponding to the second size may divide the extended area having the second size into a left area and a right area and display different information related to the event in the divided areas.

According to an embodiment, the method for controlling the electronic device may further comprise sliding out the flexible display to extend the flexible display by a third size larger than the second size based on receiving a user input in a state in which the flexible display is extended by the second size.

According to an embodiment, the method for controlling the electronic device may further comprise displaying information related to the event corresponding to the third size in the extended area having the third size.

According to an embodiment, displaying the information related to the event corresponding to the third size may divide the extended area having the third size into an upper area and a lower area and display different information related to the event in the divided areas.

According to an embodiment, sliding out the flexible display may further include determining an extension size of the flexible display based on the application corresponding to the event.

According to an embodiment, displaying the information related to the event may display a live view obtained by the camera in the extended area based on the event being execution of a camera application.

According to an embodiment, displaying the information related to the event may further include obtaining an image having the same aspect ratio as an aspect ratio of the extended area if a user input for capturing is received.

According to an embodiment, displaying the information related to the event may display a preset widget in at least a portion of the extended area.

According to an embodiment, in a non-transitory, computer-readable recording medium storing one or more programs, the one or more programs may comprise instructions that, according to an embodiment, enable the at least one processor of an electronic device to identify whether at least a portion of the flexible display is covered through the at least one sensor in a state in which the flexible display slides in with respect to the housing.

According to an embodiment, the one or more programs may comprise instructions that enable the electronic device to perform a slide-out operation of the flexible display based on an occurrence of an event in the state in which the at least a portion of the flexible display is covered.

According to an embodiment, the one or more programs may comprise instructions that enable the electronic device to display information related to the event in an area extended by the slide-out operation.

According to an embodiment, the one or more programs may comprise instructions that enable the electronic device to identify that the at least a portion of the flexible display is covered based on identifying that a flip cover is closed through the at least one sensor.

According to an embodiment, the one or more programs may comprise instructions that enable the electronic device to perform the slide-out operation of the flexible display to extend the flexible display by a first size based on the occurrence of the event.

According to an embodiment, the one or more programs may comprise instructions that enable the electronic device to display a color corresponding to an application corresponding to the event in the extended area having the first size.

According to an embodiment, the one or more programs may comprise instructions that enable the electronic device to perform the slide-out operation of the flexible display to extend the flexible display by a second size larger than the first size based on receiving a user input in a state in which the flexible display is extended by the first size.

According to an embodiment, the one or more programs may comprise instructions that enable the electronic device to display information related to the event corresponding to the second size in the extended area having the second size.

According to an embodiment, the one or more programs may comprise instructions that enable the electronic device to divide the extended area having the second size into a left area and a right area.

According to an embodiment, the one or more programs may comprise instructions that enable the electronic device to display different information related to the event in the divided areas.

According to an embodiment, the one or more programs may comprise instructions that enable the electronic device to perform the slide-out operation of the flexible display to extend the flexible display by a third size larger than the second size based on receiving a user input in a state in which the flexible display is extended by the second size.

According to an embodiment, the one or more programs may comprise instructions that enable the electronic device to display information related to the event corresponding to the third size in the extended area having the third size.

According to an embodiment, the one or more programs may comprise instructions that enable the electronic device to divide the extended area having the third size into an upper area and a lower area.

According to an embodiment, the one or more programs may comprise instructions that enable the electronic device to display different information related to the event in the divided areas.

According to an embodiment, the one or more programs may comprise instructions that enable the electronic device to determine an extension size of the flexible display based on the application corresponding to the event.

According to an embodiment, the electronic device may further comprise a camera.

According to an embodiment, the one or more programs may comprise instructions that enable the electronic device to display a live view obtained by the camera in the extended area based on the event being execution of a camera application.

According to an embodiment, the one or more programs may comprise instructions that enable the electronic device to obtain an image having the same aspect ratio as an aspect ratio of the extended area if a user input for capturing is received.

According to an embodiment, the one or more programs may comprise instructions that enable the electronic device to display a preset widget in at least a portion of the extended area.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. Thus, “connected” as used herein covers both direct and indirect connections.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a housing;
at least one sensor;
a flexible display at least partially visible to an outside;
memory storing at least one instruction; and
at least one processor, comprising processing circuitry, operatively connected to the at least one sensor, the flexible display and the memory, wherein the at least one processor, individually or collectively, is configured to execute the at least one instruction and to cause the electronic device to:
identify whether a portion of the flexible display is covered through the at least one sensor in a state in which the flexible display slides in with respect to the housing;
perform a slide-out operation of the flexible display based on an occurrence of an event in a state in which the portion of the flexible display is covered; and
display information related to the event in an area exposed by the slide-out operation, the exposed area corresponding to the covered portion.

2. The electronic device of claim 1, wherein the at least one processor is individually or collectively configured to cause the electronic device to identify that the portion of the flexible display is covered based on identifying that a flip cover is closed through the at least one sensor.

3. The electronic device of claim 1, wherein the at least one processor is individually or collectively configured to cause the electronic device to:
perform the slide-out operation of the flexible display to extend a visible area of the flexible display by a first size based on the occurrence of the event; and
displays a color corresponding to an application corresponding to the event in the exposed area having the first size.

4. The electronic device of claim 3, wherein the at least one processor is individually or collectively configured to cause the electronic device to:
perform the slide-out operation of the flexible display to extend the visible area of the flexible display by a second size larger than the first size based on receiving a user input in a state in which the visible area of the flexible display is extended by the first size; and
display information related to the event corresponding to the second size in the exposed area having the second size.

5. The electronic device of claim 4, wherein the at least one processor is individually or collectively configured to cause the electronic device to divide the exposed area having the second size into a left area and a right area and displays different information related to the event in the divided areas.

6. The electronic device of claim 4, wherein the at least one processor is individually or collectively configured to cause the electronic device to:
perform the slide-out operation of the flexible display to extend the visible area of the flexible display by a third size larger than the second size based on receiving a user input in a state in which the visible area of the flexible display is extended by the second size; and
display information related to the event corresponding to the third size in the exposed area having the third size.

7. The electronic device of claim 6, wherein the at least one processor is individually or collectively configured to cause the electronic device to divide the exposed area having the third size into an upper area and a lower area and display different information related to the event in the divided areas.

8. The electronic device of claim 1, wherein the at least one processor is individually or collectively configured to cause the electronic device to determine an extension size of the visible area of the flexible display based on the application corresponding to the event.

9. The electronic device of claim 1, further comprising a camera,
wherein the at least one processor is individually or collectively configured to:
display a live view obtained by the camera in the exposed area based on the event being execution of a camera application; and
obtain an image having the same aspect ratio as an aspect ratio of the exposed area if a user input for capturing is received.

10. The electronic device of claim 1, wherein the at least one processor is individually or collectively configured to cause the electronic device to display a preset widget in at least a portion of the exposed area.

11. A method for controlling an electronic device, the method comprising:
identifying whether a portion of a flexible display is covered through at least one sensor in a state in which the flexible display slides in with respect to a housing;
sliding out the flexible display based on an occurrence of an event in the state in which the portion of the flexible display is covered; and
displaying information related to the event in an area exposed by the slide-out operation, the exposed area corresponding to the covered portion.

12. The method of claim 11, wherein identifying that the portion of the flexible display is covered identifies that the at least a portion of the flexible display is covered based on identifying that a flip cover is closed through the at least one sensor.

13. The method of claim 11, wherein sliding out the flexible display slides out the flexible display to extend a visible area of the flexible display by a first size based on the occurrence of the event, and
wherein displaying the information related to the event displays a color corresponding to an application corresponding to the event in the exposed area having the first size.

14. The method of claim 13, further comprising:
sliding out the flexible display to extend the visible area of the flexible display by a second size larger than the first size based on receiving a user input in a state in which the visible area of the flexible display is extended by the first size; and
displaying information related to the event corresponding to the second size in the exposed area having the second size.

15. The method of claim 14, wherein displaying the information related to the event corresponding to the second size divides the exposed area having the second size into a left area and a right area and displays different information related to the event in the divided areas.

16. A non-transitory computer-readable recording medium storing at least one instruction which, when executed by at least one processor, individually or collectively, of an electronic device, causes the electronic device to perform operations including:
identifying whether a portion of a flexible display is covered through at least one sensor in a state in which the flexible display slides in with respect to a housing;
sliding out the flexible display based on an occurrence of an event in the state in which the portion of the flexible display is covered; and
displaying information related to the event in an area exposed by the slide-out operation, the exposed area corresponding to the covered portion.

17. The non-transitory computer-readable recording medium of claim 16, wherein identifying that the portion of the flexible display is covered identifies that the at least a portion of the flexible display is covered based on identifying that a flip cover is closed through the at least one sensor.

18. The non-transitory computer-readable recording medium of claim 16, wherein sliding out the flexible display slides out the flexible display to extend a visible area of the flexible display by a first size based on the occurrence of the event, and
wherein displaying the information related to the event displays a color corresponding to an application corresponding to the event in the exposed area having the first size.

19. The non-transitory computer-readable recording medium of claim 18, the operations further comprising:
sliding out the flexible display to extend the visible area of the flexible display by a second size larger than the first size based on receiving a user input in a state in which the visible area of the flexible display is extended by the first size; and
displaying information related to the event corresponding to the second size in the exposed area having the second size.

20. The non-transitory computer-readable recording medium of claim 19, wherein displaying the information related to the event corresponding to the second size divides the exposed area having the second size into a left area and a right area and displays different information related to the event in the divided areas.
